(19) United States
(12) Patent Application Publication
(10) Pub. No.: US 2010/0077467 A1
(43) Pub. Date: Mar. 25, 2010

(54) AUTHENTICATION SERVICE FOR SEAMLESS APPLICATION OPERATION

(75) Inventors: Murli Dharan Satagopan, Kirkland, WA (US); Ferhan Elvanoglu, Redmond, WA (US); Anandhi Somasekaran, Redmond, WA (US); Damien B. R. Gallot, Redmond, WA (US); Gaurav V. Navlakha, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/233,825

(22) Filed: Sep. 19, 2008

(51) Int. Cl. H04L 9/32; G06F 21/00

(52) U.S. Cl. 726/7

(57) ABSTRACT

In one embodiment, a client computer system receives user credentials from a computer user. The client computer sends the received user credentials to an authentication service running on a server computer in a datacenter, where the authentication service is configured to authenticate the user credentials so that the user is authorized to access datacenter-provided information corresponding to various client-side applications. The client computer receives an authorization indication from the authentication service indicating that the user is authorized to access the datacenter-provided information and stores the received authorization indication in a credential store on the client computer. The computer system also receives from a client-side application an authentication request to authenticate the user and automatically sends the stored authorization indication indicating that the user is authorized to access the datacenter-provided information, without prompting the user to provide user credentials for authentication.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In many cases, software applications are designed to interact with other software applications or other computer systems. For example, a client computer system might connect to a server in a datacenter to access application information. The server may be configured to ask the client for some type of authentication to verify that the client is authorized to access the requested application information. For instance, if a client wants to access email on an email server, the email server may ask the client to supply a username and a password to verify the user's identity.

In some scenarios, a client may have access to multiple applications that are either provided by an application server, or at least have portions of data provided by an application or data server. Such situations may result in a user being prompted by each application for user credentials to access the application data. This ensures that the client is authorized to access the data for each application, but can be burdensome when multiple applications are used.

### BRIEF SUMMARY

Embodiments described herein are directed to providing a client-side authentication service that allows seamless access to datacenter-provided information corresponding to various client-side applications and providing a server-side authentication service that allows seamless access to datacenter-provided information corresponding to various client-side applications. In one embodiment, a client computer system receives user credentials from a computer user. The client computer sends the received user credentials to an authentication service running on a server computer in a datacenter, where the authentication service is configured to authenticate the user credentials so that the user is authorized to access datacenter-provided information corresponding to various client-side applications.

The client computer receives an authorization indication from the authentication service indicating that the user is authorized to access the datacenter-provided information and stores the received authorization indication in a credential store on the client computer. The computer system also receives from a client-side application an authentication request to authenticate the user and automatically sends the stored authorization indication indicating that the user is authorized to access the datacenter-provided information, without prompting the user to provide user credentials for authentication.

In another embodiment, a server computer receives user credentials from a client-side authentication service, where the datacenter server provides a server-side authentication service that authenticates the received user credentials, authorizing the user to access datacenter-provided information corresponding to the user's applications. The server computer causes an authorization indication to be generated using the received user credentials, where the authorization indication indicates that the user is authorized to access the datacenter-provided information corresponding to the user's applications for a limited amount of time.

The server computer sends the generated authorization indication to the client computer, where the generated authorization indication includes an expiration stamp identifying when the authorization indication's validity ends, and receives an information request from a client-side application to access datacenter-provided information corresponding to the client-side application, where the information request includes the authorization indication. The server computer also automatically sends the requested client-side application information without prompting the user to provide user credentials for authentication, where the included authorization indication indicates that the user is authorized to access the requested information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including providing client-side and server-side authentication services that allows seamless access to datacenter-provided information corresponding to various client-side applications.

FIG. 2 illustrates a flowchart of example methods for providing client-side and server-side authentication services that allows seamless access to datacenter-provided information corresponding to various client-side applications.

FIG. 3 illustrates an embodiment of the present invention in which authentication services may be provided.

### DETAILED DESCRIPTION

Embodiments described herein are directed to providing a client-side authentication service that allows seamless access to datacenter-provided information corresponding to various client-side applications and providing a server-side authentication service that allows seamless access to datacenter-provided information corresponding to various client-side applications. In one embodiment, a client computer system receives user credentials from a computer user. The client computer sends the received user credentials to an authentication service running on a server computer in a datacenter, where the authentication service is configured to authenticate the user credentials so that the user is authorized to access datacenter-provided information corresponding to various client-side applications.

The client computer receives an authorization indication from the authentication service indicating that the user is authorized to access the datacenter-provided information and stores the received authorization indication in a credential store on the client computer. The computer system also receives from a client-side application an authentication request to authenticate the user and automatically sends the stored authorization indication indicating that the user is authorized to access the datacenter-provided information, without prompting the user to provide user credentials for authentication.

In another embodiment, a server computer receives user credentials from a client-side authentication service, where the datacenter server provides a server-side authentication service that authenticates the received user credentials, authorizing the user to access datacenter-provided information corresponding to the user's applications. The server computer causes an authorization indication to be generated using the received user credentials, where the authorization indication indicates that the user is authorized to access the datacenter-provided information corresponding to the user's applications for a limited amount of time.

The server computer sends the generated authorization indication to the client computer, where the generated authorization indication includes an expiration stamp identifying when the authorization indication's validity ends, and receives an information request from a client-side application to access datacenter-provided information corresponding to the client-side application, where the information request includes the authorization indication. The server computer also automatically sends the requested client-side application information without prompting the user to provide user credentials for authentication, where the included authorization indication indicates that the user is authorized to access the requested information.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program, code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

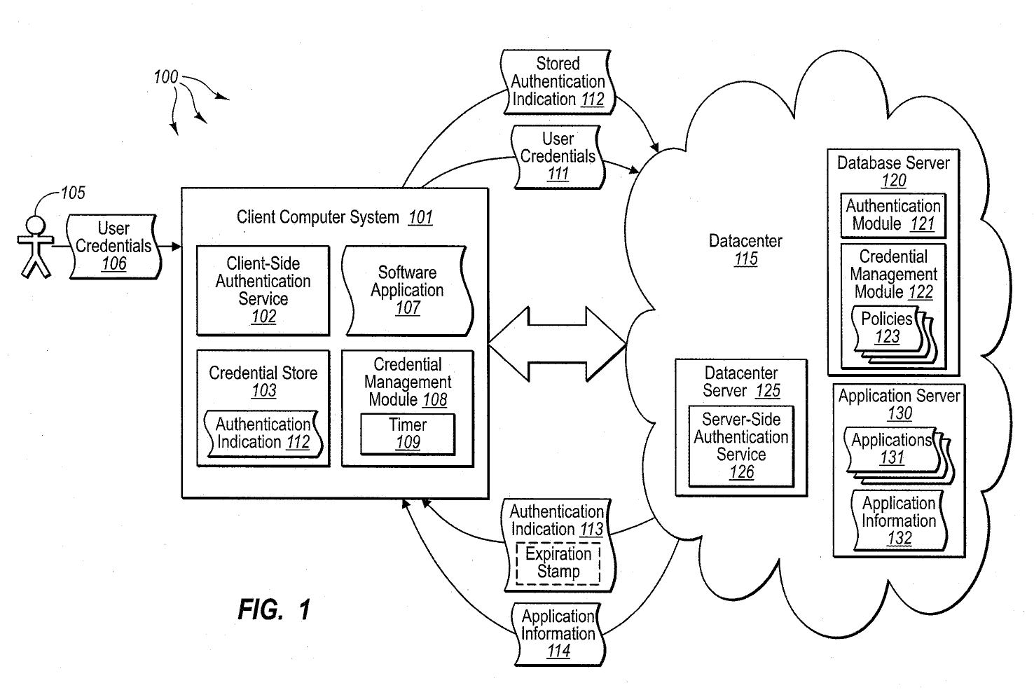

FIG. 1 illustrates a computer architecture 100 in which the principles of the present invention may be employed. Computer architecture 100 includes client computer system 101. Client computer system 101 may be any type of computer system, mobile or stationary, wired or wirelessly linked to datacenter 115 or any other computer systems (e.g. via the internet). Client computer system 101 (hereinafter system 101 or client system 101) includes client-side authentication service 102. Service 102 may be configured to receive user credentials 106 from user 105. User 105 may be any type of computer user including an end-user, developer, administrator or other user. User credentials 106 may be any element used to identify user 105. Such elements may include, for example, username, password, biometric indicators, key codes, or any other item usable to identify user 105.

Client-side authentication service 102 may be used to authenticate user 105 to another server or servers. For example, when client 105 provides credentials 106 to service 102, service 102 may be configured to send the user credentials 111 to datacenter 115. User credentials 111 may be the same as credentials 106, or they may be the processed result of an encryption or signing algorithm applied to credentials 106. Moreover, credentials 106 may be stored in credential store 103, and later retrieved and sent to datacenter 115 as credentials 111. In some embodiments, client-side authentication service 102 may be installed on computer system 101 as a stand-alone application, installed with another program as part of that program, or may be installed as a plug-in to an existing application. Service 102 may optionally run as an applet inside a browser or other software application.

As used herein, client-side authentication service 102 may be referred to as a single sign-on service. For instance, user 105 may be able to sign in (i.e. authenticate) using service 102 and from that single authentication, be able to access multiple applications that would otherwise individually prompt the user to supply sign-on credentials. For example, user 105 may be using software application 107. During operation, application 107 may need to access information stored on a server (e.g. application server 130 in datacenter 115). As will be explained in greater detail below, the application may be able to access the appropriate information stored on the server and deliver the information to the client without prompting the client for login credentials.

Client computer system 101 may also include credential management module 108 that includes timer 109. Credential management module 108 may be configured to access an expiration stamp received as part of authorization indication 113. Upon accessing the expiration stamp, module 108 may initiate timer 109 to begin timing such that when the expiration time has arrived, authorization indication 113 can be invalidated and/or deleted. Authorization indication 113 may be generated by a server computer within datacenter 115. As illustrated in FIG. 1, datacenter 115 may include database server 120, datacenter server 125 and application server 130. It should be noted that datacenter 115 may include any number of server computer systems and may include less or more than those servers shown in FIG. 1. In some embodiments, datacenter 115 may comprise a single server configured to perform all the functionality of a database server, a datacenter server and an application server. In other cases, multiple servers (possibly located in multiple, different locations) may be part of datacenter 115. In still other embodiments, multiple servers at multiple different datacenters may be used to provide application information. Any combination of datacenters and/or datacenter servers may be used to authenticate, transmit data, or perform any other corresponding computing tasks.

Datacenter server 125 may be configured to act as a gateway server that monitors some or all of the network traffic coming in to the datacenter. Server 125 includes server-side authentication service 126. As indicated above with regard to the datacenter, service 126 may be provided by any computer in datacenter 115. Server-side authentication service 126 may be a corollary service to client-side authentication service 102. That is, service 102 may communicate with service 126 to authenticate user 105 to the servers of datacenter 115. Upon receiving client credentials 111, datacenter server 125 may be configured to communicate with database server 120 (specifically authentication module 121) to determine whether user 105 is authorized to access at least some information in datacenter 115. Authentication module 121 may perform a search to determine which servers, shares and/or applications client 105 has access to in the datacenter. Authentication module 121 can then generate authorization indication 113, indicating that user 105 is authorized to access at least some information in datacenter 115. Credential management module 122 may add information or policies 123 to authorization indication 113 such as password policies, expiration stamps, or other information which can be interpreted and processed by credential management module 108 on client system 101.

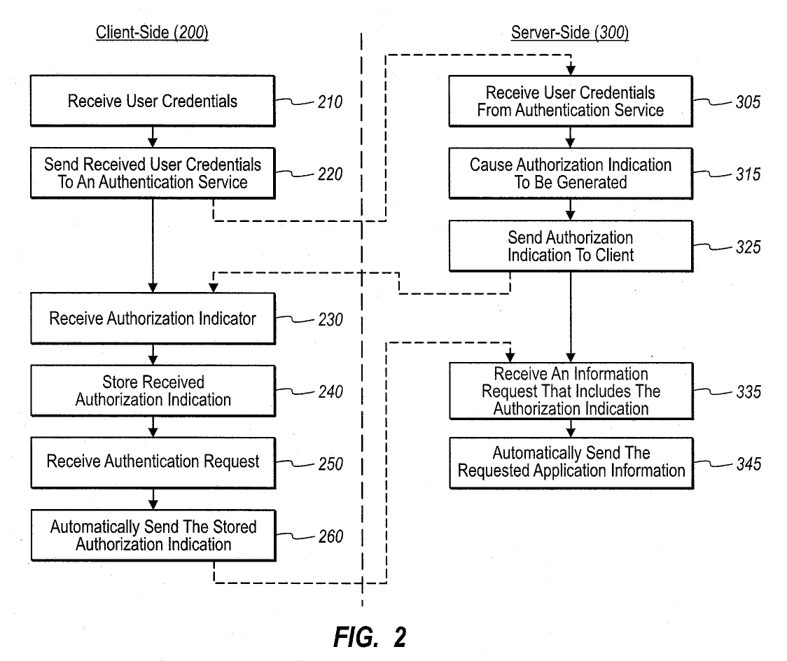

Application server 130 provides access to applications 131 and/or application information 132. In some cases, user 105 may wish to access an application provided entirely (or substantially so) by application server 130. In other cases, the application may be initiated by the client on system 101 (e.g. application 107) and may only use portions of information 132 provided by server 130. For instance, application 107 may be an email/calendaring program. The email program may be configured to access a server to download and upload the client's email and calendar updates. This and other aspects of the invention will be explained in greater detail below with regard to FIG. 2.

FIG. 2 illustrates a flowchart of method 200 and 300 for providing a client-side authentication service that allows seamless access to datacenter-provided information corresponding to various client-side applications, and providing a server-side authentication service that allows seamless access to datacenter-provided information corresponding to various client-side applications, respectively. The methods 200 and 300 will now be described with frequent reference to the components and data of environment 100.

It should be noted that, while the acts of methods 200 and 300 are depicted as occurring in the order illustrated in FIG. 2, the acts may be performed in substantially any order and may be performed out of order without the occurrence of other acts.

Method 200 includes an act of receiving at a client computer one or more user credentials from a computer user (act 210). For example, client system 101 may receive user credentials 106 from user 105. Credentials 106 may be received as part of an operating system login, or after the user is prompted to sign in to authentication service 102. For instance, in cases where service 102 is installed on system 101, service 102 may prompt the user to enter user credentials for authentication to datacenter 115. In some cases, client 105 may indicate a desire to access a software application that is either provided by application server 130 or uses information provided by application server 130. Upon receiving this indication, system 101 may prompt user 105 to install service 102 if it is not already installed on the user's computer system.

Method 200 includes an act of sending the received user credentials to an authentication service running on at least one server computer in a datacenter, the authentication service being configured to authenticate the user credentials such that the user is authorized to access datacenter-provided information provided by one or more datacenters corresponding to one or more client-side applications (act 220). For example, client system 101 may send user credentials 111 to server-side authentication service 126 running on datacenter server 125 in datacenter 115. Service 126 may be configured to authenticate user credentials 111 such that user 105 is authorized to access datacenter-provided information 132 corresponding to client-side application 107. During the authentication process, datacenter server 125 may communicate with database server 120 to determine whether user 105 is authorized to access application information 132. In some cases, datacenter server 125 may keep or consult a client profile to determine whether the user is authorized to access the information, even if the credentials are correct. For example, the client profile may indicate whether the user is current on paying membership dues, has not been blacklisted, or is otherwise not permitted to access the information, aside from having correct login credentials. In some embodiments, datacenter servers are connected via an internal network, while client system 101 connects to the datacenter over the internet. In other embodiments, system 101 may connect to the datacenter over an internal network. Many other networking connections are also possible.

Method 300 includes an act of receiving at a datacenter server computer one or more user credentials from a client-side authentication service, the datacenter server providing a server-side authentication service that authenticates the received user credentials, authorizing the user to access datacenter-provided information corresponding to the user's applications (act 305). For example, datacenter server 125 may receive user credentials 111 from client-side authentication service 102. Server-side authentication service 126 may authenticate received user credentials 111, authorizing user 105 to access datacenter-provided information 132 corresponding to client application 107. As mentioned above, datacenter server 125 may access authentication module 121 on database server 120 to determine whether user 105 is authorized (based on the received user credentials) to access at least some information provided by datacenter 115, including application information 132.

Method 300 includes an act of causing an authorization indication to be generated using the received user credentials, the authorization indication indicating that the user is authorized to access the datacenter-provided information corresponding to the user's applications for a limited amount of time (act 315). For example, datacenter server 125 may communicate with authentication module 121 to indicate that an authorization indication is to be generated using the received client credentials. The authorization indication indicates to other computer systems that user 105 is authorized to access at least information 132 for a limited amount of time. The period of validity (i.e. the time before the expiration stamp expires) is set by credential management module 122. The time may advantageously be set to expire after a relatively short amount of time, such that if the user's client machine was stolen or otherwise compromised, the authorization indication would not be valid for a substantially long period of time. In some embodiments, an expiration stamp may be added on by another computer in the datacenter (e.g. the datacenter server 125). In such cases, server 125 may query credential management module 122 of server 120 to determine the proper date and time for the expiration stamp. Either module 108 on system 101 or module 122 on server 120 may determine that the user's login credentials have expired and may notifying user 105 that he or she is to modify/update the user credentials.

Method 300 includes an act of sending the generated authorization indication to the client computer, the generated authorization indication including an expiration stamp identifying when the authorization indication's validity ends (act 325). For example, datacenter server 125 may send generated authorization indication 113 to client computer system 101, where the indication includes an expiration stamp identifying when the authorization indication's period of validity ends. In some embodiments, a credential policy (e.g. policy 123) may be included with the sent generated authorization indication, where the credential policy indicates one or more credential rules which are to be followed by client-side authentication service 102. Policies 123 may include password limitations and rules specifying how long or complex a password is to be, or other rules pertaining to biometric identifiers or other credentials. Such policies may increase network security and ensure that only properly authorized clients are provided access to the datacenter's resources.

Method 200 includes an act of receiving an authorization indication from the authentication service indicating that the user is authorized to access the datacenter-provided information (act 230). For example, computer system 101 may receive authorization indication 113 from server-side authentication service 126 indicating that user 105 is authorized to access application information 132. Indication 113 may additionally indicate that the user is authorized to access information on one or more other servers in datacenter 115. Upon receiving indication 113, computer system 101 may display an indication of the user's signed-in status on the user's computer system (i.e. system 101). The status indicator may continue to be displayed until the user logs off of authentication service 102/126.

Upon determining that user 105 has logged off, client system 101 may send an indication that the user has signed out of the client-side authentication service. Moreover, client system 101 may delete from credential store 103 any stored credentials or authorization indications 104. Credentials and/or stored indications may additionally or alternatively be deleted when the corresponding validity period has expired. For example, as mentioned above, client-side authentication service 102 has access to timer 109 and can determine from a received expiration stamp how long to wait before prompting the user to modify the user's credentials.

Method 200 includes an act of storing the received authorization indication in a credential store on the client computer (act 240). For example, authorization indication 104 may be stored in credential store 103 in system 101. In some cases, the indication may be stored in an encrypted form, so as to only be accessible to a user with a proper decryption key.

Method 200 includes an act of receiving from a client-side application an authentication request to authenticate the user (act 250). For example, user 105 may be using software application 107 which may internally send an authentication request to client-side authentication service 102, requesting the service to authenticate user 105. In some cases, service 102 may receive such a request from application server 130. For instance, user 105 may initiate an email/calendaring program on system 101. The email program may indicate to system 101 that information on another server is needed, and that, to access the information, the user is to be authenticated. The email program may send a request to datacenter 115 for the information, and may receive an authentication request. In some cases, as will be explained further below, stored authorization 112 (which may be the same as authorization indication 104) may automatically be sent to datacenter 115.

Additionally or alternatively, client system 101 may receive a second, subsequent authentication request from a second, different client-side application and automatically send stored authentication indication 112 to datacenter 115 indicating that user 105 is authorized to access the datacenter-provided information corresponding to the second, different application. Along these same lines, user 105 may use any number of applications, and may be automatically authenticated to use each separately, as a result of being signed in to single sign-on service 102. In some cases, security support provider interface (SSPI) protocol may be used by the client-side software application 107 to query credential store 103 for an authorization indication corresponding to user 105.

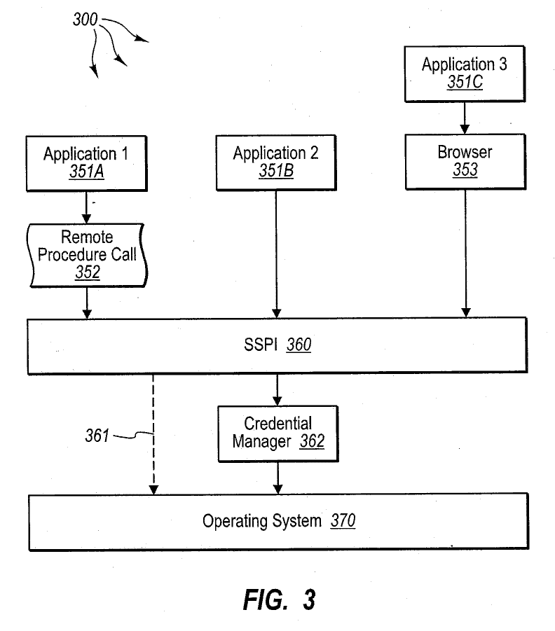

For example, as illustrated in FIG. 3, Application 1 (351A) may communicate with operating system 370 (e.g. the operating system of client system 101) via remote procedure call 352 and SSPI. Optionally, as indicated by Application 2 (351B), SSPI 360 may directly access (e.g. 361) or be channeled through credential manager 362, which may be similar or identical to credential management module 109, to apply credential policies and update the credential store. As further illustrated in FIG. 3, Application 3 (351C) may operate within internet browser 353 as a plug-in service or may use browser to communicate with operating system 370. Again, SSPI is used in the communication. In some cases, SSPI 360 may be configured to automatically query credential store 103 for any stored credentials. Thus, in one embodiment, client system 101 may receive an authentication request from application server 130 using SSPI. SSPI may automatically query credential store 103 to access any stored credentials or authentication indications. Because credential store 103 may be configured to automatically delete invalid indications (e.g. time indicated on the expiration stamp has arrived or user has signed off), an appropriate, valid indication may be sent to datacenter 115 indicating that the user is authorized to access information 132 or other information on other servers.

Method 200 includes an act of automatically sending the stored authorization indication indicating that the user is authorized to access the datacenter-provided information, without prompting the user to provide user credentials for authentication (act 260). For example, as explained above, system 101 may automatically send stored authorization indication 112 to datacenter 115 indicating that user 105 is authorized to access datacenter-provided information 132, without prompting user 105 to provide user credentials for authentication. Thus, in one embodiment, user 105 may be able to sign in to single sign-on service 102, and as the user uses various software applications, when these applications send requests for data, and the server replies with an indication that credentials are to be provided in order to access the information, the single sign-on service may automatically provide a stored authorization indication. Upon receiving such an indication, the database may send the desired information without prompting the user to log in to access information specific to each application.

Method 300 includes an act of receiving an information request from a client-side application to access datacenter-provided information corresponding to the client-side application, the information request including the authorization indication (act 335). For example, datacenter 115 may receive an information request from software application 107 to access application information 132 corresponding to application 107. The information request may advantageously include the authorization indication. Thus, when the application server 130 receives the request, server 130 can determine (e.g. by communicating with database server 125) that user 105 is authorized to access the information, and does not have to prompt the user to provide login credentials. As mentioned above, aside from determining that the client has the proper credentials, a client profile may be queried to determine, based on the client profile, whether the client is authorized to access the datacenter-provided information. The profile may include a variety of information including various reasons why a user may or may not be able to access datacenter-provided information, even if the user's credentials are proper.

In some embodiments, datacenter 115 may host a plurality of hosted applications. For example, application server 130 may provide applications 131. This may include serving the application to thin-clients, terminal computers, or other computer systems. In some cases, datacenter 115 may receive a hosted application request from user 105 to access a datacenter-provided application. Such an application request may include authorization indication 112, and may automatically provide the requested hosted application without prompting the user to provide user credentials for authentication, because the included authorization indication indicates that the user is authorized to access the requested application.

Method 300 includes an act of automatically sending the requested client-side application information without prompting the user to provide user credentials for authentication, the included authorization indication indicating that the user is authorized to access the requested information (act 345). For example, application server 130 may automatically send application information 132 to client system 101 without prompting user 105 to provide user credentials for authentication. In this manner, a user may be able to sign on to a single authentication service and automatically access application information for a variety of different applications that would otherwise prompt for authentication each time an information request was received.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computer networking environment including at least a client computer system and at least one datacenter comprising a plurality of server computer systems, a method for providing a client-side authentication service that allows seamless access to datacenter-provided information corresponding to various client-side applications, the method comprising:
an act of receiving at a client computer one or more user credentials from a computer user;
an act of sending the received user credentials to an authentication service running on at least one server computer in a datacenter, the authentication service being configured to authenticate the user credentials such that the user is authorized to access datacenter-provided information provided by one or more datacenters corresponding to one or more client-side applications;
an act of receiving an authorization indication from the authentication service indicating that the user is authorized to access the datacenter-provided information;
an act of storing the received authorization indication in a credential store on the client computer;
an act of receiving from a client-side application an authentication request to authenticate the user; and
an act of automatically sending the stored authorization indication indicating that the user is authorized to access the datacenter-provided information, without prompting the user to provide user credentials for authentication.

2. The method of claim 1, further comprising an act of displaying an indication of the user's signed-in status on the user's computer system.

3. The method of claim 1, further comprising:
an act of receiving a second, subsequent authentication request from a second, different client-side application; and
an act of automatically sending the stored authentication indication indicating that the user is authorized to access the datacenter-provided information corresponding to the second application.

4. The method of claim 1, wherein the client computer system is connected to the datacenter via the internet.

5. The method of claim 1, further comprising an act of installing the client-side authentication service on the client computer system.

6. The method of claim 1, wherein the client-side authentication service prompts the user to enter user credentials for authentication to the datacenter.

7. The method of claim 1, wherein the security support provider interface (SSPI) protocol is used by the client-side application to query the credential store for an authorization indication corresponding to the user.

8. The method of claim 7, wherein the client computer system connects to the datacenter using the authorization indication found using the SSPI protocol.

9. The method of claim 1, wherein the authentication indication has a limited period of validity.

10. The method of claim 1, further comprising:
an act of receiving an indication that the user has signed out of the client-side authentication service; and
an act of deleting the user's stored credentials in the credential store.

11. The method of claim 11, wherein the client-side authentication service includes a timer to determine from a received expiration stamp how long to wait before prompting the user to modify the user's credentials.

12. In a computer networking environment including at least a client computer system and a datacenter comprising a plurality of server computer systems, a method for providing a server-side authentication service that allows seamless access to datacenter-provided information corresponding to various client-side applications, the method comprising:
an act of receiving at a datacenter server computer one or more user credentials from a client-side authentication service, the datacenter server providing a server-side authentication service that authenticates the received user credentials, authorizing the user to access datacenter-provided information provided by one or more datacenters corresponding to the user's applications;
an act of causing an authorization indication to be generated using the received user credentials, the authorization indication indicating that the user is authorized to access the datacenter-provided information corresponding to the user's applications for a limited amount of time;
an act of sending the generated authorization indication to the client computer, the generated authorization indication including an expiration stamp identifying when the authorization indication's validity ends;
an act of receiving an information request from a client-side application to access datacenter-provided information corresponding to the client-side application, the information request including the authorization indication; and
an act of automatically sending the requested client-side application information without prompting the user to provide user credentials for authentication, the included authorization indication indicating that the user is authorized to access the requested information.

13. The method of claim 12, further comprising an act of querying a second, different server in the datacenter to determine the proper date and time for the expiration stamp.

14. The method of claim 13, further comprising:
an act of determining that the password has expired; and
an act of notifying the client computer system that the user is to modify the user credentials.

15. The method of claim 12, further comprising an act of including a credential policy with the sent generated authorization indication, the credential policy indicating one or more credential rules which are to be followed by a client-side authentication service.

16. The method of claim 12, further comprising an act of querying a client profile database to determine, based on the client profile whether the client is authorized to access the datacenter-provided information.

17. The method of claim 12, wherein the act of causing an authorization indication to be generated using the received user credentials, the authorization indication indicating that the user is authorized to access the datacenter-provided information corresponding to the user's applications for a limited amount of time comprises the following:
an act of sending the received user credentials to a second, different server computer of the datacenter, such that the second, different server generates the authorization indication indicating that the user is authorized to access the datacenter-provided information corresponding to the user's applications for a limited amount of time; and
an act of receiving from the second, different server computer the generated authorization indication.

18. The method of claim 12, wherein the datacenter hosts a plurality of hosted applications.

19. The method of claim 18, further comprising:
receiving a hosted application request from the user to access a datacenter-provided application, the hosted application request including the authorization indication; and
an act of automatically providing the requested hosted application without prompting the user to provide user credentials for authentication, the included authorization indication indicating that the user is authorized to access the requested application.

20. A computer system comprising the following:
one or more processors;
system memory;
one or more computer-readable storage media having thereon computer-executable instructions that, when executed by the one or more processors, causes the computing system to perform a method for providing a client-side authentication service that allows seamless access to datacenter-provided information corresponding to various client-side applications, the method comprising the following:
an act of an act of receiving at a client computer one or more user credentials from a computer user;
an act of sending the received user credentials to an authentication service running on at least one server computer in a datacenter, the authentication service being configured to authenticate the user credentials such that the user is authorized to access datacenter-provided information provided by one or more datacenters corresponding to one or more client-side applications;
an act of receiving an authorization indication from the authentication service indicating that the user is authorized to access the datacenter-provided information;
an act of storing the received authorization indication in a credential store on the client computer;
an act of receiving from a client-side application an authentication request to authenticate the user;
an act of automatically sending the stored authentication indication indicating that the user is authorized to access the datacenter-provided information, without prompting the user to provide user credentials for authentication;
an act of requesting a credential expiration value for the stored authorization indication generated based on the user's credentials;
an act of receiving an indication from the datacenter identifying an expiration value for the stored authorization indication; and
an act of initiating a timer so that, based on the expiration value received from the datacenter, the client knows when to prompt the user to input updated credentials.
